(19) United States
(12) Patent Application Publication
(10) Pub. No.: US 2013/0101152 A1
(43) Pub. Date: Apr. 25, 2013

(54) DISPLAY WITH SOUND BOX

(71) Applicant: HWANG-MIAW CHEN, Tu-Cheng (TW)

(72) Inventor: HWANG-MIAW CHEN, Tu-Cheng (TW)

(73) Assignee: HON HAI PRECISION INDUSTRY CO., LTD., Tu-Cheng (TW)

(21) Appl. No.: 13/598,636

(22) Filed: Aug. 30, 2012

(30) Foreign Application Priority Data
Oct. 21, 2011 (CN) 201110322687.7

(51) Int. Cl. H04R 1/02

(52) U.S. Cl. 381/388

(57) ABSTRACT

An exemplary display includes a front frame, a rear frame, a screen sandwiched between the front frame and the rear frame, and two sound boxes received between the front frame and the rear frame. Two openings are defined in a bottom of the display. Each sound box includes a front cover, a rear cover, and a woofer and two tweeters mounted in the front cover. The woofer faces a front and a corresponding opening of the display. The tweeters face the corresponding opening of the display.

### BACKGROUND

1. Technical Field

The disclosure generally relates to displays, and more particularly to a display typically having a left sound box and a right sound box.

2. Description of Related Art

Sound boxes may occupy a large amount of space when positioned on a support such as a table or a desk. Furthermore, when the sound boxes are used in conjunction with a computer such as a personal computer, some wires are needed to connect the sound boxes to the computer so that the sound boxes receive sound signals from the computer. Thus, for saving space and creating a neat environment, sound boxes are often incorporated into a display of the computer. A typical sound box incorporated in a display includes a shell, and a woofer and a tweeter mounted in the shell. The shell is received in a chamber of the display in a manner that the woofer and the tweeter both face a front panel of the display. The chamber has a bottom opening communicating with an outside environment. Thus, sound produced from the woofer and the tweeter is firstly reflected by the front panel and then spread to the outside environment through the opening of the chamber. However, the high-frequency sound produced from the tweeter is highly directional. That is, the reflection by the front panel significantly affects the quality of the high-frequency sound. Accordingly, distortion of the high-frequency sound is increased.

What is needed, therefore, is a display with one or more sound boxes to overcome the described limitations.

### BRIEF DESCRIPTION OF THE DRAWINGS

Many aspects of the present embodiments can be better understood with reference to the following drawings. The components in the drawings are not necessarily drawn to scale, the emphasis instead placed upon clearly illustrating the principles of the present embodiments. Moreover, in the drawings, like reference numerals designate corresponding parts throughout the views.

FIG. 1 is a front plan view of a display in accordance with an embodiment of the present disclosure.

FIG. 2 is an enlarged, perspective view of a left sound box of the display of FIG. 1.

FIG. 3 is an exploded view of the left sound box of FIG. 2.

FIG. 4 is an enlarged, perspective view of a right sound box of the display of FIG. 1.

FIG. 5 is an exploded view of the right sound box of FIG. 4.

### DETAILED DESCRIPTION

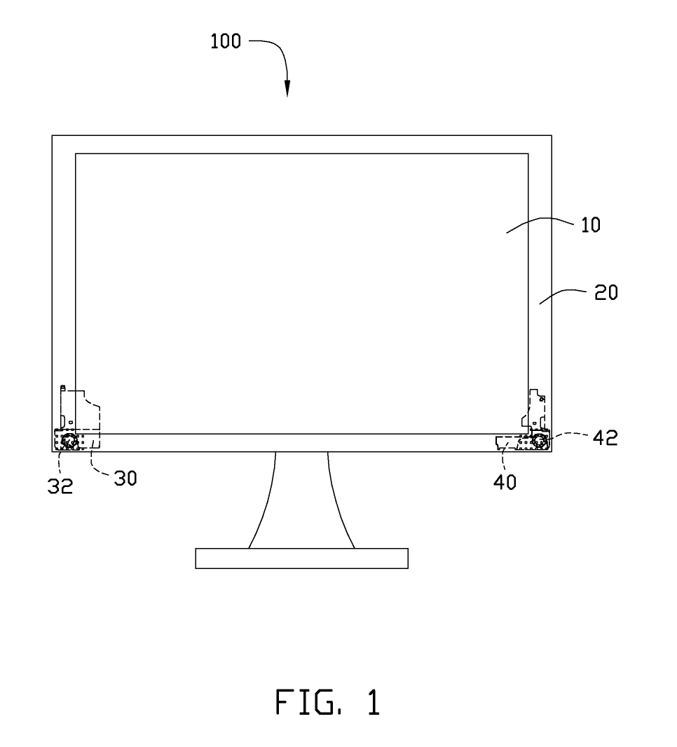

Referring to FIG. 1, a display 100 in accordance with an embodiment of the present disclosure is shown. The display 100 of this embodiment is a liquid crystal display. Alternatively, other types of displays may instead be used, such as an organic light emitting display or a plasma display. The display 100 includes a front frame 20, a rear frame (not visible) fixed to the front frame 20, and a screen 10 sandwiched between the front frame 20 and the rear frame. The front frame 20 defines a large window (not labeled) in a central area thereof so that the screen 10 is visible through the window. Two openings (not visible) are defined in a bottom of the display 100, at two opposite lateral sides (i.e., a left side and a right side) of the screen 10, respectively. Typically, each opening is defined in both the front frame 20 and the rear frame. A left sound box 30 and a right sound box 40 are received between the front frame 20 and the rear frame, corresponding to the two openings, respectively.

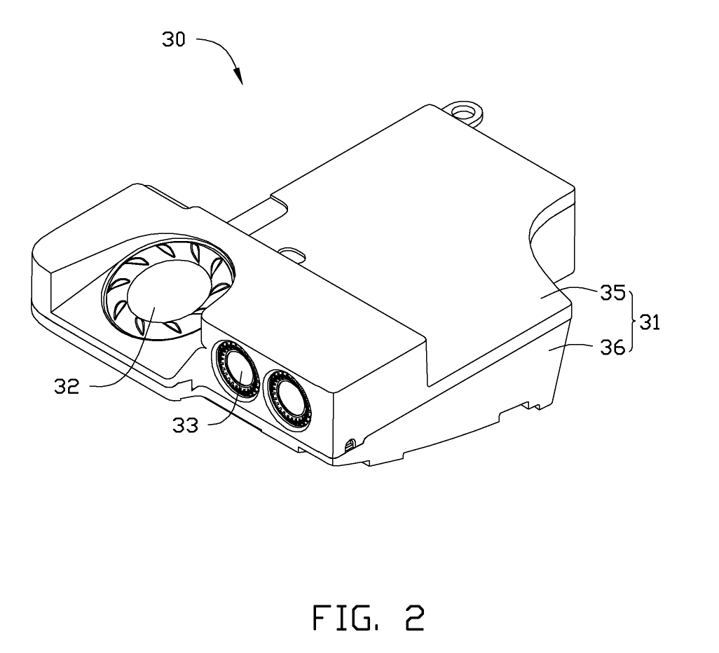

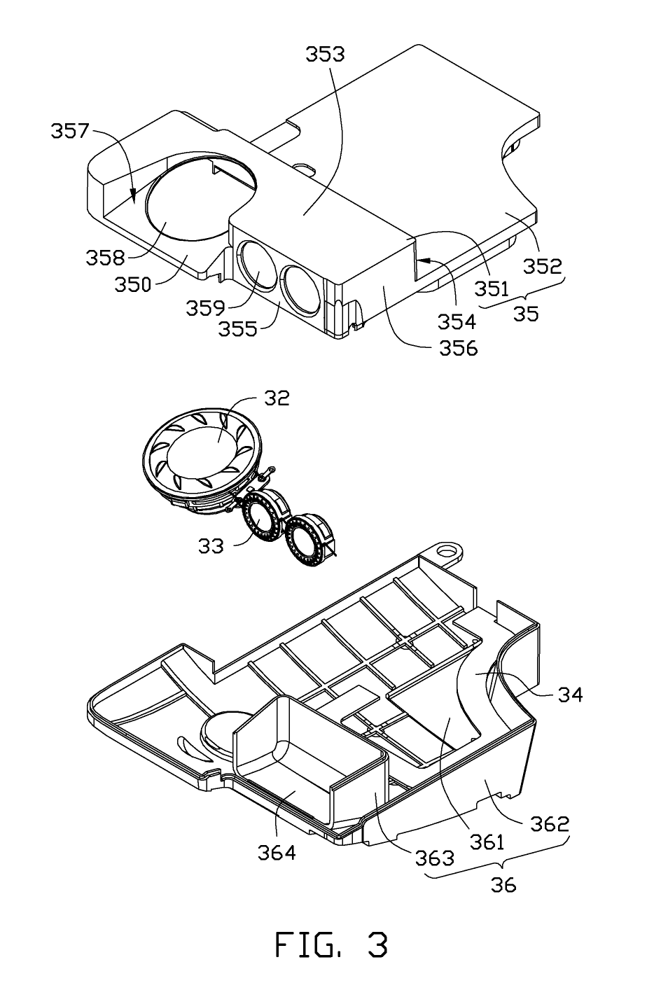

Also referring to FIGS. 2-3, the left sound box 30 includes a shell 31, which includes a front cover 35 and a rear cover 36 fixed to the front cover 35. The left sound box 30 also includes a woofer 32 and two tweeters 33 all mounted in the front cover 35.

The front cover 35 includes a panel 352, and a housing 351 connected to the panel 352. The panel 352 is parallel to the screen 10 when the left sound box 30 is vertically mounted between the front frame 20 and the rear frame. The housing 351 is located adjacent to the left opening of the display 100. The housing 351 includes a top plate 354 connecting the panel 352, a bottom plate 355 parallel to the top plate 354, a front plate 353, and two side plates 356 interconnecting the top plate 354 and the bottom plate 355. The top plate 354 is perpendicular to the panel 352. The front plate 353 is perpendicular to the top plate 354 and the two side plates 356. The two side plates 356 are perpendicular to the top plate 354. A depression 357 is defined in the front plate 353 and the bottom plate 355 cooperatively. A depth of the depression 357 as measured in a front-to-back direction is gradually increased along a top-to-bottom direction of the housing 351. Thus an inmost wall 350 of the depression 357 is inclined relative to the front plate 353 and the bottom plate 355. A through hole 358 is defined in the inmost wall 350 of the depression 357. The woofer 32 is received in the through hole 358. The woofer 32 thus faces towards the bottom and a front of the display 100. Two through holes 359 are defined in the bottom plate 355 of the housing 351. The two tweeters 33 are received in the two through holes 359, respectively. The tweeters 33 thus face towards the bottom of the display 100.

The rear cover 36 includes a main plate 361, a plurality of flanges 362 extending perpendicularly rearward from a periphery of the main plate 361, and a plurality of sidewalls 363 formed on the main plate 361. The sidewalls 363 cooperatively enclose a chamber 364 therebetween. The chamber 364 is located adjacent to a bottom one of the flanges 362 of the rear cover 34, and corresponds to the two through holes 359 of the front cover 35. A driving board 34 is mounted on the main plate 361. The rear cover 36 is fixed to the front cover 35 to enclose the housing 351 of the front cover 35. The two tweeters 33 are received in the chamber 364 of the rear cover 36 for improving the quality of high-frequency sound produced by the tweeters 33. The driving board 34 is electrically connected to the tweeters 33 and the woofer 32, for driving the tweeters 33 and the woofer 32 to produce sound.

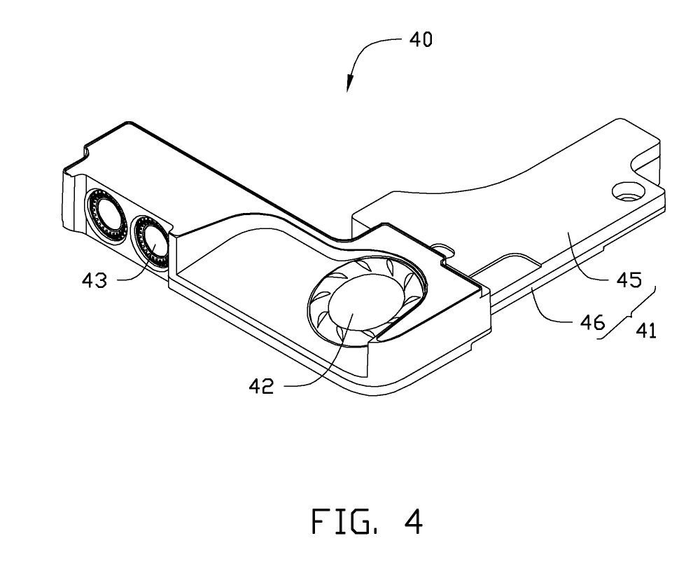

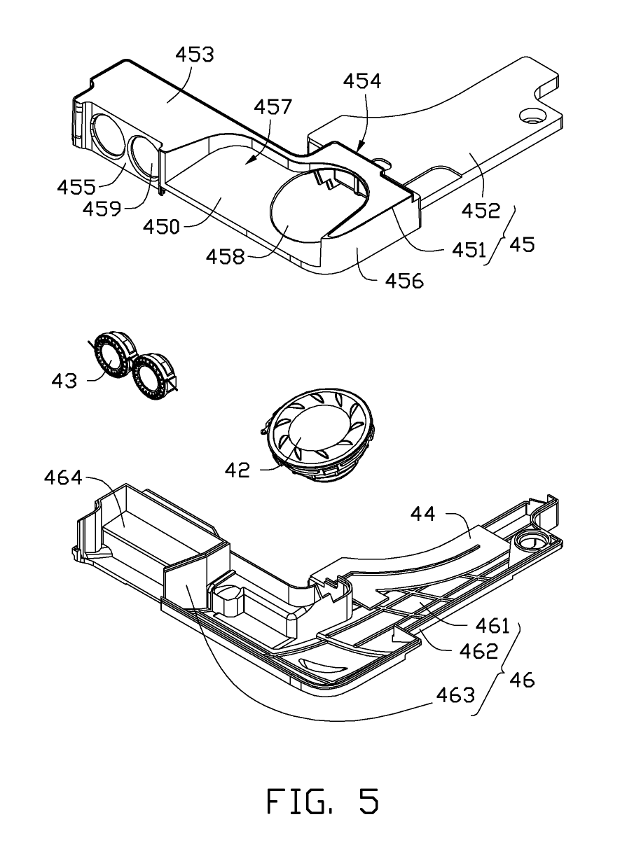

Also referring to FIGS. 4-5, the right sound box 40 has a configuration similar to the left sound box 30. The right sound box 40 includes a shell 41, which includes a front cover 45 and a rear cover 46 fixed to the front cover 45. The right sound box 40 also includes two tweeters 43 and a woofer 42 mounted in the front cover 45. The front cover 45 includes a panel 452, and a housing 451 connected to the panel 452. The panel 452 of the right sound box 40 is smaller than the panel 352 of the left sound box 30, and the housing 451 of the right sound box 40 is longer than the housing 351 of the left sound box 30.

The right sound box 40 is vertically mounted between the front frame 20 and the rear frame, in a manner than the panel 452 is parallel to the screen 10 and the housing 451 is located adjacent to the right opening of the display 100. The housing 451 includes a top plate 454, a bottom plate 455 parallel to the top plate 454, a front plate 453, and two side plates 456 interconnecting the top plate 454 and the bottom plate 455. The top plate 454 is perpendicular to the front plate 453 and the side plates 456. The side plates 456 are perpendicular to the front plate 453. A depression 457 is defined in the front plate 453 and the bottom plate 455 cooperatively. The depression 457 has a depth as measured in a front-to-back direction gradually increasing along a top-to-bottom direction of the housing 451. An inmost wall 450 of the depression 457 is inclined relative to the front plate 453. A through hole 458 is defined in the inmost wall 450 of the depression 457. The woofer 42 is received in the through hole 458. The woofer 42 thus faces the front and the bottom of the display 100. Two through holes 459 are defined in the bottom plate 455 adjacent to the depression 457. The two tweeters 43 are received in the two through holes 459, respectively. The tweeters 43 thus face the bottom of the display 100. Each tweeter 43 is smaller than the woofer 42.

The rear cover 46 includes a main plate 461, a plurality of flanges 462 extending perpendicularly rearward from a periphery of the main plate 461, and a plurality of sidewalls 463 formed on the main plate 461. The sidewalls 463 enclose a chamber 464 therebetween. The chamber 464 is located adjacent to a bottom one of the flanges 462, and corresponds to the two through holes 459 of the front cover 45. A driving board 44 is mounted on the main plate 461. The rear cover 46 is fixed to the front cover 45 such that the tweeters 43 are received in the chamber 464 and the woofer 42 is received between the front cover 45 and the rear cover 46. The driving board 44 is electrically connected to the woofer 42 and the tweeters 43.

Since the tweeters 33, 43 directly face the bottom of the display 100, the high-frequency sound produced by the tweeters 33, 43 is not blocked and can directly transmit to an outside environment through the openings of the display 100. Thus, the quality of the high-frequency sound is improved, and distortion of the high-frequency sound is lowered or even eliminated altogether. Furthermore, the inclined orientations of the woofers 32, 42 can also allow part of low-frequency sound produced by the woofers 32, 42 to directly exit the openings of the display 100 to the outside environment, whereby the quality of the low-frequency sound is also improved.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A display comprising:
a front frame;
a rear frame;
a screen sandwiched between the front frame and the rear frame, an opening defined in a bottom of the display; and
a sound box received between the front frame and the rear frame, the sound box comprising a tweeter orientated downwardly and facing the opening.

2. The display of claim 1, wherein the sound box comprises a front cover receiving the tweeter.

3. The display of claim 2, wherein the front cover comprises a housing having a top plate, a bottom plate substantially parallel to the top plate and a front plate interconnecting the top plate and the bottom plate, the bottom plate defining a through hole receiving the tweeter.

4. The display of claim 3, wherein the front cover further comprises a panel connecting the top plate of the housing.

5. The display of claim 3, wherein the front plate is substantially perpendicular to the top plate.

6. The display of claim 3, wherein the front plate is substantially parallel to the screen.

7. The display of claim 3, wherein the housing defines a depression in the front plate and the bottom plate cooperatively.

8. The display of claim 7, wherein the depression has a depth as measured in a front-to-rear direction gradually increasing along a top-to-bottom direction of the housing.

9. The display of claim 8, wherein the depression has an inmost wall inclined relative to the front plate, another through hole being defined in the inmost wall of the depression.

10. The display of claim 9, wherein the sound box further comprises a woofer received in the another through hole of the housing.

11. The display of claim 10, wherein the woofer faces the bottom and a front of the display.

12. The display of claim 10, wherein the woofer has a size larger than that of the tweeter.

13. The display of claim 10, wherein the sound box further comprises a rear cover connected to the front cover, the tweeter and the woofer being received between the front cover and the rear cover.

14. The display of claim 13, wherein the rear cover comprises a main plate and a driving board mounted on the main plate, the tweeter and the woofer being electrically connected to the driving board.

15. The display of claim 14, wherein the rear cover further comprises a plurality of sidewalls formed on the main plate, the sidewalls cooperatively surrounding a chamber, the chamber receiving the tweeter.

16. The display of claim 15, wherein the chamber is located adjacent to the bottom of the display.

17. The display of claim 14, wherein the rear cover further comprises a plurality of flanges extending substantially perpendicularly from a periphery of the main plate.

18. The display of claim 1, wherein the sound box is vertically mounted between the front frame and the rear frame.

19. The display of claim 1, further comprising another sound box received between the front frame and the rear frame, wherein the sound box and the another sound box are mounted at two opposite sides of the display.

20. The display of claim 1, wherein the display is one of a liquid crystal display, an organic light emitting display and a plasma display.
